(19) United States
(12) Patent Application Publication
(10) Pub. No.: US 2019/0242352 A1
(43) Pub. Date: Aug. 8, 2019

(54) ENGINE CONTROL APPARATUS

(71) Applicant: DENSO CORPORATION, Kariya-city, Aichi-pref. (JP)

(72) Inventor: Shogo HOSHINO, Kariya-city (JP)

(73) Assignee: Denso Corporation, Kariya-city, Aichi-pref. (JP)

(21) Appl. No.: 16/301,281

(22) PCT Filed: Apr. 27, 2017
(86) PCT No.: PCT/JP2017/016762

§ 371 Date: Nov. 13, 2018

(30) Foreign Application Priority Data
May 10, 2016 (JP) 2016-094758

(51) Int. Cl. F02N 19/00; F02N 11/08

(52) U.S. Cl. CPC F02N 19/005; F02N 11/0814; F02N 2019/008; F02N 2250/04; F02N 2200/021; F02N 2300/104

(57) ABSTRACT

An ECU is applied to an engine system including an engine and an MG. The ECU determines whether or not a piston is located at a position, at which compression reactive force is received, at a time point at which engine speed reaches zero after combustion of the engine is stopped. Further, in a case where the ECU determines that the piston is located at the position at which compression reactive force is received, the ECU stops the piston by applying positive torque on a positive rotation side to a crank shaft by the MG.

### CROSS-REFERENCE TO RELATED APPLICATION

The present application is based on and claims the benefit of priority from earlier Japanese Patent Application No. 2016-094758 filed on May 10, 2016, the description of which is incorporated herein by reference.

### TECHNICAL FIELD

The present disclosure relates to an engine control apparatus.

### BACKGROUND ART

In a vehicle, when an engine is stopped, there is a case where vibration may occur by swing-back (inverse rotation) of rotation of the engine, and the vibration may provide a feeling of discomfort to the driver. This occurs by a piston being pushed back by a pressure within a cylinder when rotation of an engine output shaft is stopped.

For example, in a technique disclosed in PTL 1, in a vehicle having an idling stop function, swing-back occurring when rotation of an engine output shaft is stopped is predicted. Then, in the case where it is determined that swing-back will occur, control is performed so that a piston gets over a top dead center by applying torque on a positive rotation side to the engine output shaft by using a starter motor. By this means, occurrence of swing-back is suppressed.

### CITATION LIST

### Patent Literature

[PTL 1] JP 2012-102620 A

### SUMMARY OF THE INVENTION

However, in the case where control is performed so that the piston gets over the top dead center, it is not certain whether the piston is actually stopped at an appropriate position. As a result, there is a probability that swing-back may occur again.

The present disclosure is mainly directed to providing an engine control apparatus which is capable of suppressing vibration in association with inverse rotation of an engine by suppressing occurrence of the inverse rotation of the engine.

A first disclosure is an engine control apparatus which is applied to an engine system including an engine in which a cycle including each stroke of compression and expansion is repeatedly performed, and a rotating electrical machine which is capable of applying positive torque on a positive rotation side and counter torque on an inverse rotation side to an engine output shaft, the engine control apparatus including a determining section configured to determine whether or not a piston is located at a position, at which compression reactive force is received, at a time point at which engine speed reaches zero after combustion of the engine is stopped, and a torque control section configured to, in the case where it is determined by the determining section that the piston is located at the position at which the compression reactive force is received, stop the piston by applying positive torque on a positive rotation side to the engine output shaft by the rotating electrical machine.

When rotation of the engine is stopped, there is a case where compression reactive force is received according to a position where the piston is stopped. In such a case, the engine inversely rotates by the piston being pushed back, and, as a result, vibration occurs.

According to the above-described configuration, it is determined whether or not the piston is located at a position, at which compression reactive force is received, at a time point at which rotation of the engine is stopped, and, in the case where it is determined that the piston is located at the position at which compression reactive force is received, positive torque is applied. In this case, by applying positive torque against the generated compression reactive force, it is possible to prevent the piston from being pushed back. By this means, it is possible to suppress occurrence of inverse rotation of the engine and suppress vibration in association with the inverse rotation of the engine.

A second disclosure is the engine control apparatus including an estimating section configured to estimate the position of the piston at the time point at which the engine speed reaches zero, in which the torque control section controls a torque value by the rotating electrical machine based on the position of the piston estimated by the estimating section.

Compression reactive force received by the piston largely changes in accordance with a position of the piston when rotation of the engine is stopped. For example, the compression reactive force received by the piston becomes larger as the position of the piston is closer to a compression top dead center. With the above-described configuration, a configuration is employed in which the position of the piston when rotation of the engine is stopped is estimated, and a torque value of the positive torque is controlled based on the position. By this means, it is possible to provide positive torque appropriate for compression reactive force in accordance with a position where the piston is stopped.

A third disclosure is the engine control apparatus in which, after application of the positive torque by the rotation electric machine is started, the torque control section stops the application of the positive torque in association with disappearance of the compression reactive force.

The compression reactive force generated within the cylinder gradually decreases and finally disappears because air within the cylinder comes out as time passes. With the above-described configuration, after application of positive torque is started, application of the positive torque is stopped in association with disappearance of the compression reactive force. By this means, it is possible to prevent the engine from being rotated as a result of positive torque becoming excessive when compression reactive force disappears.

A fourth disclosure is the engine control apparatus in which the torque control section gradually reduces the positive torque as time passes from the time point at which the engine speed reaches zero.

As time passes, the compression reactive force within the cylinder gradually decreases since rotation of the engine is stopped. With the above-described configuration, a configuration is employed in which the positive torque applied to the engine output shaft is gradually reduced as time passes in accordance with change of the pressure within the cylinder. By this means, it is possible to maintain an appropriate balance between the compression reactive force and force of the positive torque.

A fifth disclosure is the engine control apparatus including an estimating section configured to estimate a position of the piston at the time point at which the engine speed reaches zero, in which the torque control section sets a time period during which torque is applied by the rotating electrical machine based on the position of the piston estimated by the estimating section.

As a result of the magnitude of the compression reactive force received by the piston largely changing in accordance with the position of the piston when rotation of the engine is stopped, a time period taken for the compression reactive force to disappear also changes. With the above-described configuration, a time period during which positive torque is applied is set based on the estimated stop position of the piston. By this means, it is possible to apply positive torque during a period during which the compression reactive force is generated in accordance with the position of the piston.

A sixth disclosure is the engine control apparatus including a rotation speed determining section configured to determine that the piston is located at a compression top dead center immediately before the engine speed becomes zero based on engine speed at the compression top dead center of the engine in a rotation drop period during which the engine speed drops to zero after the combustion of the engine is stopped, and a stop determining section configured to determine whether or not the piston is stopped at a rotation angle position in a first half period of an expansion stroke, in which, in a case where it is determined by the rotation speed determining section that the piston is located at the compression top dead center immediately before the engine speed becomes zero, the torque control section applies counter torque by the rotating electrical machine from the compression top dead center, and in a case where it is determined by the stop determining section that the piston is not stopped at the rotation angle position in the first half period of the expansion stroke after the counter torque is applied by the rotating electrical machine, the torque control section stops the piston by applying positive torque on the positive rotation side to the engine output shaft by the rotating electrical machine.

With the above-described configuration, first, the piston to which the counter torque is applied is controlled to be stopped at a position in the first half of the expansion stroke, as the crank angle stop processing. Then, in the case where the piston is not stopped at the desired position, positive torque is applied as backup processing. By this means, it is possible to further suppress occurrence of inverse rotation of the engine, so that it is possible to improve an effect of suppressing vibration.

### BRIEF DESCRIPTION OF DRAWINGS

The above and other objects, features and advantages of the present disclosure will become clearer from the following detailed description with reference to the accompanying drawings, in which

FIG. 1 is a schematic configuration diagram of an engine control system,

FIG. 2 is a transition chart of engine speed in a rotation drop period,

FIG. 3 is a flowchart illustrating processing of stopping the engine speed,

FIG. 4 is a flowchart of processing of setting counter torque,

FIG. 5 is a flowchart of crank angle stop processing,

FIG. 6 is a correlation diagram illustrating correlation between a crank angle and an initial torque value,

FIG. 7 is a timing diagram illustrating an aspect of the processing of stopping the engine speed,

FIG. 8 is a timing diagram illustrating an aspect of the crank angle stop processing,

FIG. 9 is a timing diagram of backup processing.

### DESCRIPTION OF EMBODIMENTS

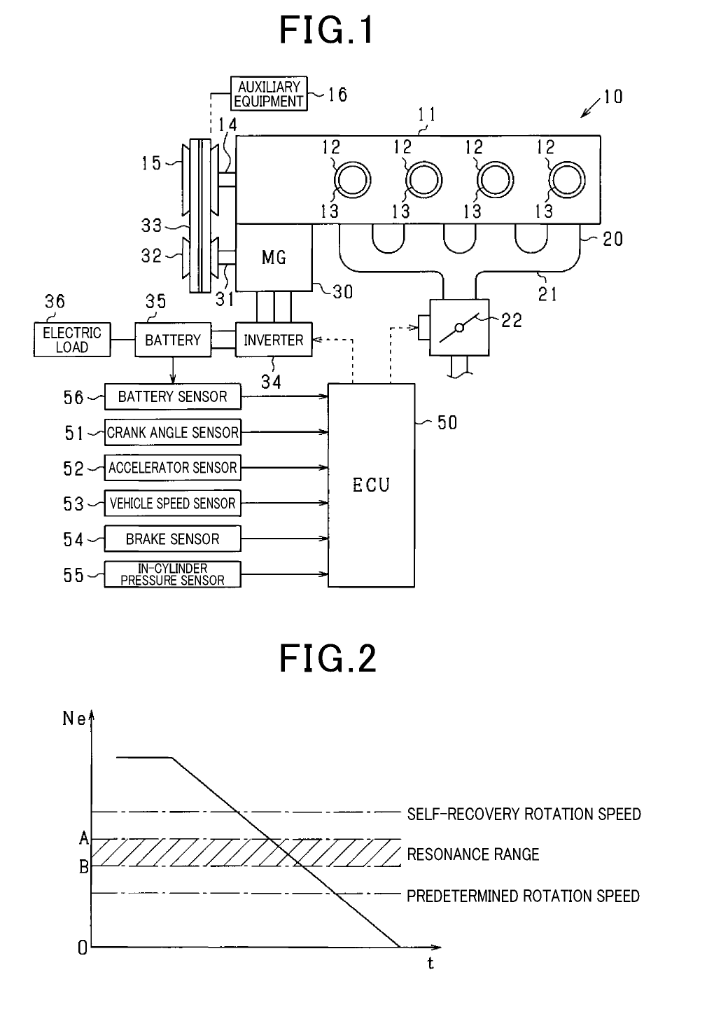

An embodiment of the present disclosure will be described below on the basis of the drawings. In the present embodiment, a control system for an engine installed in a vehicle is embodied. In the control system, an operation state, or the like, of the engine is controlled mainly with an electronic control unit (hereinafter, referred to as an ECU). An overall schematic diagram of the present system is illustrated in FIG. 1.

In a vehicle 10 illustrated in FIG. 1, an engine 11 is a four-stroke engine which is driven through combustion of fuel such as gasoline, and which repeatedly performs respective strokes of intake, compression, expansion and exhaust. The engine 11 has four cylinders 12, and a piston 13 is disposed in each of the cylinders 12. Further, the engine 11 includes a fuel injection valves (not illustrated), ignition devices (not illustrated), or the like, as appropriate. Note that, while, in the present embodiment, an engine with four cylinders is illustrated, the engine may have any number of cylinders. Further, the engine 11 is not limited to a gasoline engine, and may be a diesel engine.

To the cylinder 12, air is supplied from an intake part 20. The intake part 20 includes an intake manifold 21, and a throttle valve 22 which adjusts the amount of air intake is provided upstream of the intake manifold 21.

In the engine 11, an MG (motor generator) 30 is integrally provided. The MG 30 is rotating electrical machine which is driven as an electric motor and a generator. A crank shaft (engine output shaft) 14 of the engine 11 is mechanically connected to a crank pulley 15, and a rotating shaft 31 of the MG 30 is mechanically connected to an MG pulley 32. The crank pulley 15 is drive-coupled to the MG pulley 32 with a belt 33. When the engine starts, initial rotation (cranking rotation) is provided to the engine 11 by rotation of the MG 30. Note that, it is also possible to employ a configuration in which a starter motor is separately provided, and initial rotation is provided to the engine 11 by rotation of the starter motor.

Further, the MG 30 is connected to a battery 35 via an inverter 34 which is a power conversion circuit. In the case where the MG 30 is driven as an electric motor, electric power is supplied to the MG 30 from the battery 35 via the inverter 34. Meanwhile, in the case where the MG 30 functions as a generator, after electric power generated by the MG 30 is converted from AC to DC in the inverter 34, the battery 35 is charged with the electric power. Note that electric loads 36 such as lamps and an audio device is connected to the battery 35.

In the vehicle 10, as auxiliary devices which are driven by rotation of the crank shaft 14, in addition to the MG 30, auxiliary equipment 16 such as a water pump, a fuel pump and a compressor of an air conditioner is mounted. Note that the auxiliary devices include a device whose coupled state with the crank shaft 14 is intermitted by a clutch means, in addition to a device such as the auxiliary equipment 16 which is drive-coupled to the engine 11 with a belt or the like.

The ECU 50, which is an electronic control apparatus including a microcomputer, and the like, configured by well-known CPU, ROM, RAM, and the like, performs various kinds of engine control such as opening degree control of the throttle valve 22 and control of fuel injection by the fuel injection valve on the basis of detection results of various kinds of sensors provided in the present system.

For details of sensors, to the ECU 50, a crank angle sensor 51 which detects a rotational position of the crank shaft 14 and engine speed Ne, an accelerator sensor 52 which detects the operation amount of an accelerator (accelerator opening degree), a vehicle speed sensor 53 which detects vehicle speed, a brake sensor 54 which detects the operation amount of a brake pedal, an in-cylinder pressure sensor 55 which detects an in-cylinder pressure within a cylinder, and a battery sensor 56 which detects a battery state of the battery 35 are connected, and signals from these sensors are sequentially input to the ECU 50.

Examples of the crank angle sensor 51 can include an electromagnetic pickup type rotational position detecting means, or the like, which outputs a rectangular detection signal (crank pulse signal) for each predetermined crank angle (for example, with a period of 10° CA). The engine speed Ne is calculated from a time period taken every time the crank shaft 14 rotates by 10° CA. Further, from the detection result of the rotational position, as well as the rotational position of the crank shaft 14 with respect to a predetermined reference position (for example, a compression top dead center) being calculated, a stroke of the engine 11 is determined.

The battery sensor 56 detects a voltage between terminals, a charge/discharge current, or the like, of the battery 35. On the basis of these detection values, the remaining capacity (SOC) of the battery 35 is calculated.

Further, the ECU 50 performs idling stop control of the engine 11. In the idling stop control, generally, combustion of the engine 11 is stopped when predetermined automatic stop conditions are fulfilled, and, thereafter, the engine 11 is restarted when predetermined restart conditions are fulfilled. In this case, the automatic stop conditions include, for example, a condition that vehicle speed of the own vehicle is within an automatic stop speed range (for example, vehicle speed 10 km/h) and accelerator operation is cancelled or brake operation is performed. Further, the restart conditions include, for example, a condition that accelerator operation is started, and a condition that brake operation is cancelled. Note that it is also possible to employ a configuration in which an engine control function and an idling stop function are implemented by different ECUs 50.

Here, in the vehicle 10, if the automatic stop conditions of the engine 11 are fulfilled from an idle state, combustion of the engine 11 is stopped. Thereafter, the engine speed Ne gradually decreases and becomes zero. FIG. 2 illustrates transition of the engine speed Ne in a rotation drop period until the engine speed Ne becomes zero after combustion of the engine 11 is stopped. According to decrease in the engine speed Ne, the engine speed Ne passes through self-recovery rotation speed, a resonance range of the engine, and predetermined rotation speed set in advance (for example, approximately 200 rpm). Here, the self-recovery rotation speed is a lower limit of rotation speed at which the engine can be restarted by supply of fuel being resumed without cranking being performed while combustion of the engine 11 is stopped, and is, for example, set to approximately 500 rpm.

The resonance range of the engine refers to a range of the engine speed in which resonance occurs, and is, for example, set to 300 to 400 rpm. Here, resonance is a phenomenon in which an excitation frequency corresponding to the engine speed is excited by matching with a resonance frequency of a power plant such as the engine body and an automatic transmission. By this phenomenon, vibration increases in the resonance range of the engine. In this manner, vibration in the resonance range is one factor of unpleasant vibration occurring when the engine is stopped.

Note that the resonance range of the engine is provided on a lower rotation side than idle rotation speed and on a higher rotation side than cranking rotation speed of a conventional starter so as to minimize vibration caused by resonance. Therefore, the engine speed Ne passes through the resonance range during the rotation drop period until the engine speed Ne reaches zero after combustion of the engine is stopped.

Meanwhile, also immediately before rotation of the engine is stopped, vibration occurs by swing-back (inverse rotation) of the engine. This vibration occurs due to a piston being pushed back in a direction of a bottom dead center by compression reactive force within the cylinder when the engine is stopped. Note that vibration occurring in the resonance range negatively affects vibration due to this inverse rotation.

The present embodiment describes engine control in the rotation drop period until the engine speed Ne becomes zero after combustion of the engine 11 is stopped. Here, the rotation drop period is divided into three periods on the basis of the engine speed Ne. That is, a period from when combustion of the engine 11 is stopped until when the engine speed Ne reaches a boundary value A on a higher rotation side of the resonance range is set as a first period, a period during which the engine speed Ne is within the resonance range is set as a second period, and a period from when the engine speed Ne passes through a boundary value B on a lower rotation side of the resonance range until when the engine speed Ne reaches zero is set as a third period. In the present embodiment, engine control is performed in accordance with respective periods.

In the first period, when the automatic stop conditions are fulfilled, and combustion of the engine 11 is stopped, the opening degree of the throttle valve 22 is set larger than that in an idle rotating state. By this means, the amount of air required to restart the engine is secured.

In the second period, rotation drop processing of increasing a drop rate of the engine speed Ne in the resonance range is performed. By this means, it is possible to shorten a time period during which the engine speed Ne passes through the resonance range, so that it is possible to suppress vibration occurring due to the resonance range.

Further, in the third period, torque on the inverse rotation side (counter torque) is applied to the crank shaft 14 so that the piston 13 is stopped at a crank rotational position in a first half of the expansion stroke when rotation of the crank shaft 14 is stopped. Further, in the case where the piston 13 is not stopped at the crank rotational position in the first half of the expansion stroke, torque on a positive rotation side (positive torque) is applied to the crank shaft 14 as backup processing. By this means, inverse rotation of the engine is suppressed, so that it is possible to suppress vibration occurring due to the inverse rotation of the engine.

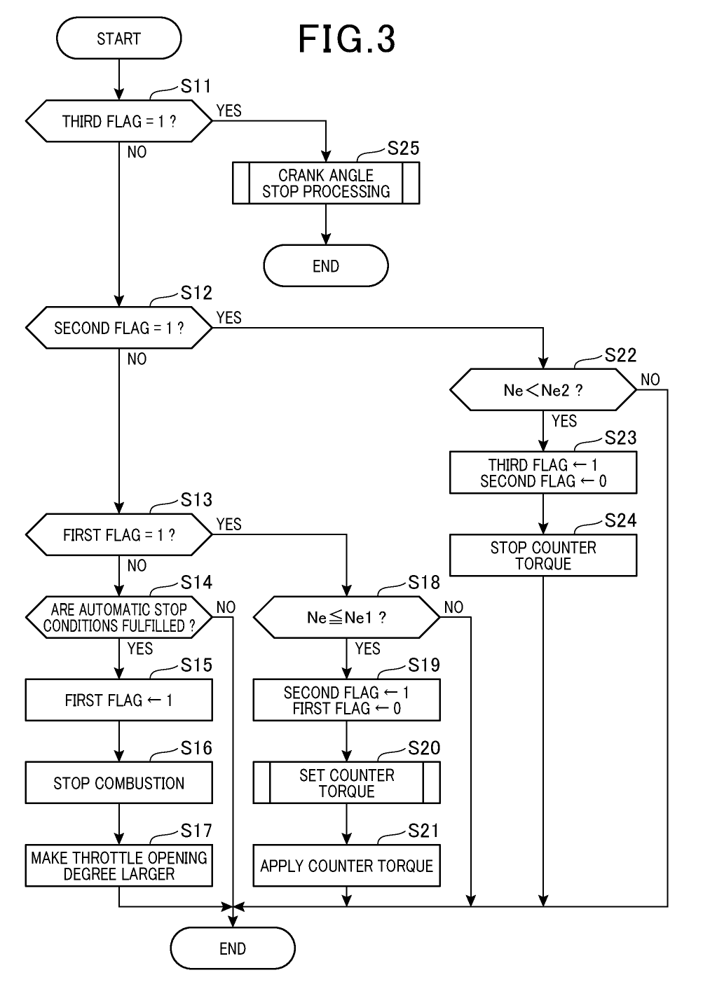

FIG. 3 is a flowchart illustrating a processing procedure concerning engine control, and the present processing is repeatedly executed with a predetermined period (for example, 10 ms) by the ECU 50.

First, flags will be described. A first flag, a second flag and a third flag in the drawing respectively correspond to the above-described first period, second period and third period, and indicate whether the engine speed Ne is within each of the periods. Each of the flags indicates that the engine speed Ne is within the period in a case of “1”, and indicates that the engine speed Ne is not within the period in a case of “0”. Note that all the flags are set at “0” in initial setting.

In step S11, it is determined whether or not the third flag is “1”. In step S12, it is determined whether or not the second flag is “1”. In step S13, it is determined whether or not the first flag is “1”. In the case where negative determination results are obtained in step S11 to step S13 in an initial state, the processing proceeds to step S14, in which it is determined whether or not the engine automatic stop conditions are fulfilled. Then, in the case where a negative determination result is obtained in step S14, the present processing is finished without any further processing being performed.

Meanwhile, in the case where it is determined in step S14 that the engine automatic stop conditions are fulfilled, the processing proceeds to step S15, in which the first flag is set to “1”. In the following step S16, combustion of the engine 11 is stopped, and the processing proceeds to step S17. In step S17, the opening degree of the throttle valve 22 is made larger than the opening degree in the idle rotating state (specifically, the opening degree is made larger than the degree opening in the idle rotating state by equal to or greater than 10%, and is, for example, made full opening), and the present processing is finished.

In this manner, control is performed so that the opening degree of the throttle valve 22 is made larger than the opening degree in the idle rotating state when combustion of the engine 11 is stopped. Note that the processing in step S17 corresponds to a throttle control section.

Meanwhile, in the case where it is determined in step S13 that the first flag is “1”, the processing proceeds to step S18, in which it is determined whether or not the engine speed Ne is equal to or less than predetermined rotation speed Ne1. Note that, in the present embodiment, the boundary value A on the higher rotation side of the resonance range is set as the predetermined rotation speed Ne1. That is, in step S18, it is determined whether or not the engine speed Ne has reached the boundary value A on the higher rotation side of the resonance range.

In the case where it is determined in step S18 that the engine speed Ne is greater than the predetermined rotation speed Ne1, the present processing is finished without any further processing being performed. Meanwhile, in the case where it is determined in step S18 that the engine speed Ne is equal to or less than the predetermined rotation speed Ne1, that is, in the case where the engine speed Ne has transitioned to the resonance range, the processing proceeds to step S19, in which the second flag is set to “1”, and the first flag is reset to

If the engine speed Ne has transitioned to the resonance range, processing of increasing the drop rate of the engine speed Ne is executed. As the processing of increasing the drop rate, in the present embodiment, counter torque is applied using the MG 30 which is an auxiliary device. Then, in step S20, first, the counter torque is set.

The MG 30 has a power generation function as a generator and a power driving function as an electric motor, and application of counter torque is executed using the respective functions. Here, counter torque is greater in power running driving than in regenerative power generation, and regenerative power generation excels in fuel consumption compared to power running driving. Therefore, it is preferable to use each of the functions in accordance with an operation state. In such a case, which function is used is judged on the basis of various parameters. In the present embodiment, regenerative power running generation or power driving of the MG 30 is selected in accordance with power consumption of the electric loads 36 connected to the battery 35, a state of the remaining capacity of the battery 35, required torque required for application of counter torque, and a load by operation of the auxiliary equipment 16. Further, in this case, in the case where power consumption of the electric loads 36 is large, or in the case where the load of the auxiliary equipment 16 is large, regenerative power generation is selected, and, in the case where the remaining capacity of the battery 35 is large, or in the case where the required torque of the counter torque is large, power driving running is selected.

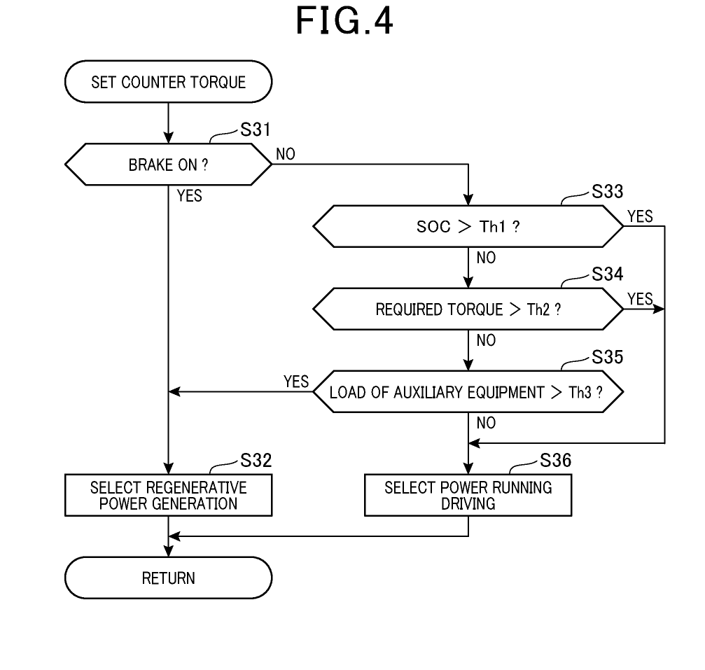

FIG. 4 illustrates a flowchart of setting of the counter torque. First, in step S31, it is determined whether or not the power consumption of the electric loads 36 is equal to or greater than a predetermined value. For example, examples of the electric loads 36 can include, lamps, an electric pump, or the like. More specifically, it is determined whether or not a brake pedal is being depressed. Since a brake lamp is lit in a state where the brake pedal is depressed, power consumption becomes large. In the case where it is determined in step S31 that the brake pedal is being depressed, the processing proceeds to step S32, and it is determined to apply counter torque through regenerative power generation. In this case, since power consumed by the electric loads 36 is large, by utilizing regenerative power generation, it is possible to suppress vibration while reducing a burden on the battery 35.

Meanwhile, in the case where a negative determination result is obtained in step S31, the processing proceeds to step S33, and a function is selected depending on the remaining capacity of the battery 35. Here, for example, it is determined whether or not the SOC of the battery 35 is greater than a threshold Th1. In the case where it is determined in step S33 that the SOC is greater than the threshold Th1, the processing proceeds to step S36, and it is determined to apply counter torque through power running driving. Note that a value of the threshold Th1 may be changed as appropriate, and, for example, may be a value from which it can be judged that the battery 35 is in a fully charged state if the SOC is greater than the threshold Th1.

Here, in calculation of the SOC, an estimation method based on an open circuit voltage (OCV) and a calculation method through current integration are used. Here, an open circuit voltage of the battery 35 is acquired, the SOC is estimated using the acquired value and a map indicating the correspondence relationship between the open circuit voltage and the SOC, a charge/discharge current flowing through the battery 35 is acquired, and the SOC is calculated by performing calculation processing on the acquired value. Note that, in the case where counter torque is applied through power running driving, greater counter torque may be set as the remaining capacity is greater. In this case, since it is possible to further shorten a time period during which the engine speed Ne passes through the resonance range, it can be considered that an effect of suppressing vibration is improved.

Meanwhile, in the case where a negative determination result is obtained in step S33, the processing proceeds to step S34, and a function is selected depending on the required torque of the counter torque. For example, it is determined whether or not the required torque is greater than a threshold Th2. In the case where it is determined in step S34 that the required torque is greater than the threshold Th2, the processing proceeds to step S36, and it is determined to apply counter torque through power running driving.

Further, in the case where a negative determination result is obtained in step S34, the processing proceeds to step S35, and a function is selected depending on the load of the auxiliary equipment 16. For example, it is determined whether or not the load from operation of the auxiliary equipment 16 is greater than a threshold Th3. In the case where it is determined in step S35 that the load is greater than the threshold Th3, the processing proceeds to step S32, and it is determined to apply counter torque through regenerative power generation. Meanwhile, in the case where a negative determination result is obtained in step S35, the processing proceeds to step S36, and it is determined to apply counter torque through power running driving. As described above, after regenerative power generation or power running driving is determined on the basis of the parameters, the processing transitions to step S21 in FIG. 3, and counter torque is applied.

Here, application of counter torque through power running driving corresponds to first rotation drop processing, and application of counter torque through regenerative power generation corresponds to second rotation drop processing.

Then, in the case where it is determined in step S12 in FIG. 3 that the second flag is “1”, the processing proceeds to step S22, in which it is determined whether or not the engine speed Ne is less than predetermined rotation speed Ne2. Note that, in the present embodiment, the boundary value B on the lower rotation side of the resonance range is set as the predetermined rotation speed Ne2. That is, in step S22, it is determined whether or not the engine speed Ne has passed through the boundary value B on the lower rotation side of the resonance range.

In the case where it is determined in step S22 that the engine speed Ne is less than the predetermined rotation speed Ne2, that is, in the case where the engine speed Ne has transitioned to the third period, the processing proceeds to step S23, in which the third flag is set to “1”, and the second flag is reset to “0”. In the following step S24, the counter torque applied in step S21 is stopped. Meanwhile, in the case where it is determined in step S22 that the engine speed Ne is equal to or greater than the predetermined rotation speed Ne2, the present processing is finished without any further processing being performed.

Note that the processing in step S18 and step S22 corresponds to a resonance range determining section which determines that the engine speed passes through the resonance range of the engine. Further, the processing in step S20 and step S21 corresponds to a rotation drop control section. In this manner, in the present embodiment, in the case where it is determined that the engine speed passes through the resonance range, counter torque is applied to the engine output shaft by using either power running driving or regenerative power generation of the rotating electrical machine.

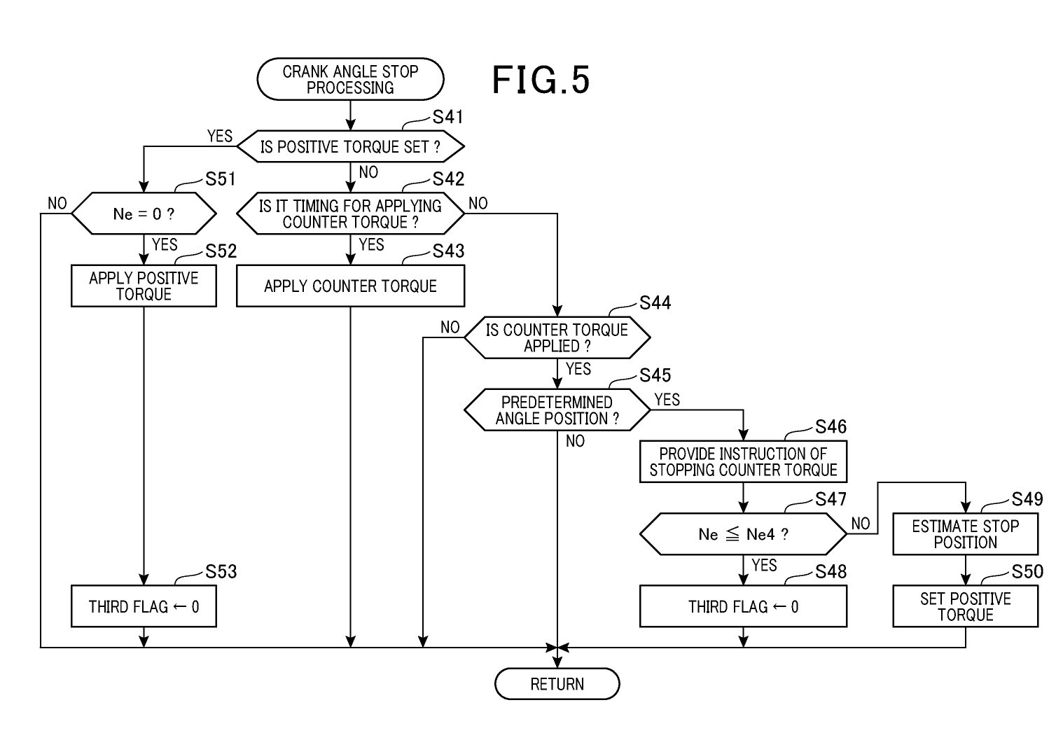

Then, in the case where it is determined in step S11 that the third flag is “1”, the processing proceeds to step S25, in which processing of a subroutine illustrated in FIG. 5 is executed. That is, when the engine speed Ne transitions to the third period, crank angle stop processing for suppressing inverse rotation of the engine is performed. Here, counter torque is applied at predetermined timing based on the engine speed so that the piston 13 is stopped at a position in a first half of an expansion stroke, that is, the piston 13 of the next combustion cylinder is stopped at a position in a first half of a compression stroke. That is, in the crank angle stop processing, control is performed so that the piston 13 is not stopped at a position in a second half of the compression stroke, that is, the piston 13 is not stopped at a position at which compression reactive force is generated. Further, in the case where the piston 13 is not stopped at a desired position by application of counter torque, backup processing of applying positive torque to the engine output shaft is executed when the engine speed Ne has become zero. In this case, by applying positive torque against the compression reactive force within the cylinder to the engine output shaft, it is possible to suppress inverse rotation of the engine.

In step S41 in FIG. 5, first, it is determined whether or not positive torque to be applied is set as the backup processing. This positive torque is set in the case where the piston 13 is not stopped at a desired position by application of counter torque in the crank angle stop processing. In an early stage after the engine speed Ne transitions to the third period, negative determination result is obtained in step S41, and the processing proceeds to step S42. In step S42, it is determined whether or not it is timing for applying counter torque to the engine output shaft. In the present embodiment, for example, in the case where the engine speed Ne when the piston 13 is located at a compression TDC is equal to or less than predetermined rotation speed Ne3, it is determined that it is timing for applying counter torque. Here, in the case where it is determined that it is timing for applying counter torque, the processing proceeds to step S43, in which counter torque is applied to the engine output shaft, and the present processing is finished.

Note that the predetermined rotation speed Ne3 is rotation speed at which it is determined that rotation of the engine output shaft is stopped until the piston passes through a first half period of the expansion stroke by counter torque being applied from timing at which the piston is located at the compression TDC.

Meanwhile, in the case where it is determined in step S42 that it is not timing for applying counter torque, the processing proceeds to step S44, in which it is determined whether or not counter torque is applied. Here, in the case where a negative determination result is obtained in step S44, the present processing is finished without any further processing being performed.

Meanwhile, in the case where it is determined in step S44 that counter torque is applied, the processing proceeds to step S45, in which it is determined whether or not the crank rotational position detected by the crank angle sensor 51 is a set predetermined angle (for example, ATDC70° CA). In the case where it is determined that the rotational position is the predetermined angle, the processing proceeds to step S46, in which an instruction of stopping the counter torque applied in step S43 is provided. By this means, the counter torque applied to the engine output shaft is stopped. Meanwhile, in the case where a negative determination result is obtained in step S45, the present processing is finished without any further processing being performed.

In step S47, it is determined whether or not the engine speed Ne is equal to or less than predetermined rotation speed Ne4. In the case where it is determined in step S47 that the engine speed Ne is equal to or less than the predetermined rotation speed Ne4, that is, in the case where it is determined that the piston 13 is stopped at the position in the first half of the expansion stroke, the processing proceeds to step S48, in which the third flag is reset to “0”, and the present processing is finished.

Note that step S45 and step S47 correspond to a stop determining section. The predetermined rotation speed Ne4 at the predetermined angle can be arbitrarily changed, and only has to be a value from which it can be determined whether or not the piston 13 is actually stopped at the crank rotational position in the first half of the expansion stroke after the counter torque is applied in step S43.

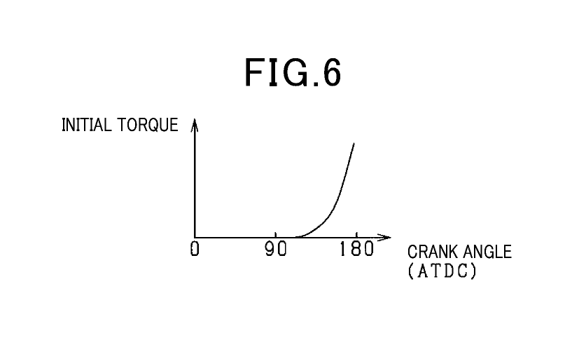

Meanwhile, in the case where it is determined in step S47 that the engine speed Ne is greater than the predetermined rotation speed Ne4, the processing proceeds to step S49, and the processing transitions to backup processing. First, in step S49, a stop position of the piston 13 when the engine speed Ne becomes zero is estimated. Here, the stop position of the piston 13 can be, for example, estimated from actual engine speed Ne at the predetermined angle position in step S45. After the stop position of the piston 13 is estimated, the processing proceeds to step S50, in which an initial torque value of the positive torque is set on the basis of the estimated stop position. Here, FIG. 6 illustrates correlation between the stop position of the piston 13 and the initial torque value. The initial torque value is generated approximately when the crank rotational position exceeds the crank angle ATDC90° CA, and becomes greater as the crank rotational position comes closer to the crank angle ATDC180° CA (compression TDC). Since positive torque is applied against the compression reactive force within the cylinder, the initial torque value becomes greater as the crank rotational position comes closer to the crank angle ATDC180° CA (compression TDC) at which the compression reactive force becomes the greatest.

Further, the compression reactive force generated within the cylinder gradually decreases and finally disappears because air within the cylinder comes out as time passes. Therefore, to maintain a balance between the compression reactive force and force of the positive torque, the torque value of the positive torque is preferably controlled in accordance with change of the compression reactive force. Therefore, in step S50, transition of the torque value from the initial torque value, in which passage of time is taken into account, is also set. Note that the transition of the torque value can be calculated by, for example, multiplying initial torque by a predetermined attenuation rate. Further, the transition of the torque value can be also calculated by using a map, or the like, which is set in advance in accordance with the compression reactive force and time.

If the positive torque is set in step S50 in FIG. 5, an affirmative determination result is obtained in step S41. Subsequently, the processing proceeds to step S51, in which it is determined whether or not the engine speed Ne has become zero. Here, if it is determined that the engine speed Ne has become zero, the processing proceeds to step S52, in which the positive torque set in step S50 is applied. That is, in this case, positive torque is applied in accordance with the initial torque value in accordance with the estimated stop position and transition of the torque value. Then, the third flag is reset to “0” in step S53, and the present processing is finished. Meanwhile, in the case where it is determined in step S51 that the engine speed Ne is not zero, the present processing is finished without any processing being performed.

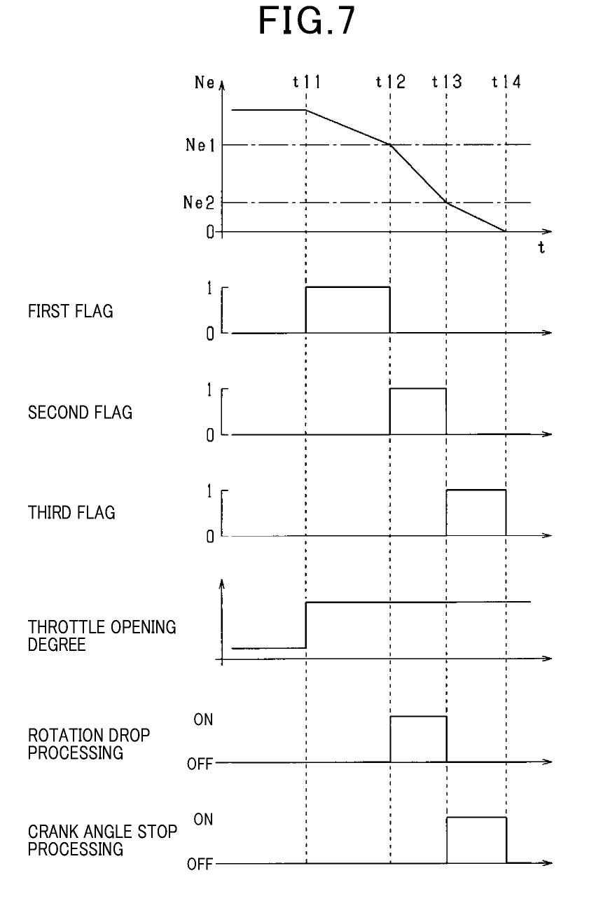

Next, engine control in the rotation drop period until the engine speed Ne completely becomes zero after combustion of the engine 11 is stopped will be described with reference to a timing diagram in FIG. 7.

First, if the automatic stop conditions are fulfilled at timing t11 from the idle state, the first flag is set to “1”. At this time, the opening degree of the throttle valve 22 is controlled to be larger than the opening degree in the idle state. Thereafter, if the engine speed Ne becomes equal to or less than the predetermined rotation speed Ne1 at timing t12, at the same time as the second flag being set to “1”, the first flag is reset to “0”. At this time, counter torque is applied to the engine output shaft as the rotation drop processing. Then, if the engine speed Ne falls below the predetermined rotation speed Net at timing t13, at the same time as the third flag being set to “1”, the second flag is reset to “0”. At this time, the rotation drop processing is stopped, and in the following third period, the crank angle stop processing is executed. Then, the engine speed Ne becomes zero at timing t14.

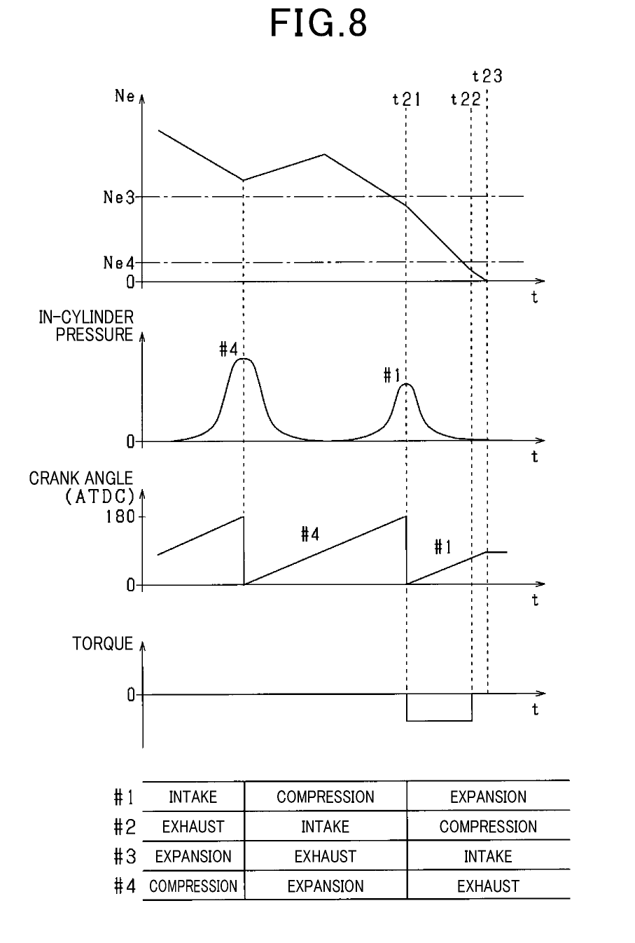

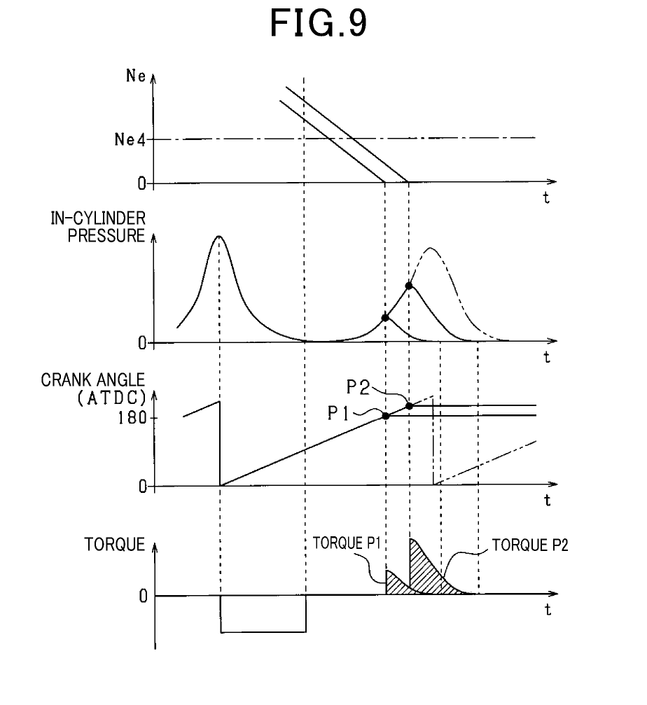

Subsequently, the crank angle stop processing in the case where the engine speed Ne is within the third period will be described with reference to timing diagrams in FIG. 8 and FIG. 9. These respectively illustrate cases of different determination results in step S47 in FIG. 5 after counter torque is applied. FIG. 8 illustrates a case where an affirmative determination result is obtained in step S47, and only counter torque is applied in the third period, while FIG. 9 illustrates a case where a negative determination result is obtained in step S47, and positive torque is applied when rotation of the engine is stopped, as the backup processing. Note that these drawings illustrate change of an in-cylinder pressure of each cylinder. The in-cylinder pressure increases as the piston 13 comes closer to the compression TDC, and becomes the maximum at the compression TDC. Further, a local maximum value of the in-cylinder pressure decreases as the engine speed Ne decreases.

In FIG. 8, while the engine speed Ne drops, when the engine speed Ne becomes equal to or less than Ne3 at timing t21 (at timing at which a first cylinder (#1) reaches the compression TDC), counter torque is applied to the engine output shaft, which leads to increase in a drop rate of the engine speed Ne. Then, when the engine speed Ne at timing t22 (at timing at which the first cylinder (#1) reaches a predetermined crank angle position (for example, ATDC70° CA)) becomes equal to or less than the predetermined rotation speed Ne4, application of the counter torque is stopped. Thereafter, rotation of the engine 11 is stopped at timing t23. At this time, the piston 13 of the first cylinder (#1) is stopped at a position in the first half of the expansion stroke (for example, ATDC80° CA). Note that firing order of the respective cylinders is #1, #2, #3 and #4 for the purpose of illustration.

FIG. 9 illustrates processing in the case where the piston 13 is not stopped at the desired position by application of counter torque by crank angle stop processing, and, for example, is stopped at a position of P1 (for example, around ATDC130° CA) and a position of P2 (for example, around ATDC160° CA), as the backup processing. In the case where the piston 13 is stopped at the position of P1 when the engine speed Ne becomes zero, since an in-cylinder pressure is generated, the piston 13 receives compression reactive force. At this time, positive torque corresponding to the generated compression reactive force is applied to the engine output shaft. Thereafter, the in-cylinder pressure gradually decreases because air comes out from the cylinder as time passes. In this case, the torque value also decreases as time passes in accordance with transition of the in-cylinder pressure. Then, application of the positive torque is stopped in accordance with timing at which the in-cylinder pressure disappears. Note that, by positive torque in balance with the compression reactive force being applied, the piston 13 is held at the position of P1.

Meanwhile, in the case where the piston 13 is stopped at the position of P2, the in-cylinder pressure becomes higher than that in a case of P1. Therefore, the initial torque value of the positive torque against the compression reactive force also becomes greater than that in the case of P1. Thereafter, in a similar manner to the case of P1, the torque value decreases in accordance with transition of the in-cylinder pressure. Note that, also in this case, since a balance between the compression reactive force and the positive torque is maintained, the piston 13 is held at the position of P2.

According to the present embodiment described in detail above, it is possible to obtain the following advantageous effects.

In a vehicle having an idling stop function, when combustion of the engine 11 is stopped, by making the opening degree of the throttle valve 22 larger than the opening degree in the idle rotating state, it is possible to secure a sufficient amount of air required when the engine restarts. Further, by applying counter torque by using the MG 30 so that a drop rate of the engine speed is increased in the resonance range, it is possible to shorten a time period during which the engine speed passes through the resonance range. In this case, while there is a concern that vibration is increased in the resonance range in a state where the throttle opening degree is large, by shortening the time period during which the engine speed passes through the resonance range, it is possible to suppress the increase in vibration. By this means, in a vehicle having an idling stop function, it is possible to secure startability when the engine restarts while suppressing occurrence of vibration when the engine is automatically stopped.

A configuration is employed in which the opening degree of the throttle valve 22 is made larger than the opening degree in the idle rotating state at a time point at which combustion of the engine 11 is stopped. By this means, even in the case where restart conditions are fulfilled immediately after combustion is stopped, it is possible to secure a sufficient amount of air, so that startability when the engine restarts becomes favorable.

A configuration is employed in which, in the resonance range, counter torque is applied by using the MG 30. In this case, it is possible to apply greater counter torque to the engine output shaft compared to torque applied by using the auxiliary equipment 16. Therefore, a time period during which the engine speed passes through the resonance range is further shortened, so that an effect of suppressing vibration is improved.

Further, a configuration is employed in which, in application of counter torque using the MG 30, regenerative power generation or power running driving can be selected. Here, counter torque is greater in power running driving than in regenerative power generation, and regenerative power generation excels in fuel consumption compared to power running driving. By this means, it is possible to select a drive system while taking respective advantages of regenerative power generation and power driving in accordance with an operation state.

A configuration is employed in which, concerning selection of the drive system of the MG 30, regenerative power generation or power running driving can be selected depending on power consumption of the electric loads 36 connected to the battery 35. In this case, in the case where power consumption of the electric loads 36 is greater than a predetermined value, since the battery 35 is burdened, counter torque is applied through regenerative power generation. By this means, it is possible to suppress vibration while maintaining a stable power supply state of the battery 35.

Specifically, a configuration is employed in which, in a case of a state where a brake pedal is depressed, counter torque is applied while regenerative power generation is selected. In a state where the brake pedal is depressed, power consumption of the battery 35 increases in association with lighting of a brake lamp. Therefore, it is possible to suppress vibration while maintaining a stable power supply state of the battery 35.

A configuration is employed where, concerning selection of the drive system of the MG 30, further, regenerative power generation or power running driving can be selected on the basis of the remaining capacity of the battery 35. In this case, in the case where the remaining capacity is greater than the threshold Th1, counter torque is applied through running power driving. In the case where there is large remaining capacity of the battery 35, there is a concern that the battery 35 is overcharged by the rotating electrical machine being caused to perform regenerative power generation. Concerning this point, by counter torque being applied through power running driving, it is possible to suppress vibration occurring due to the resonance range without damaging the battery 35.

A configuration is employed where, in the case where it is determined that the piston is located at a compression top dead center immediately before the engine speed becomes zero in the third period, counter torque is applied from the compression top dead center by using the MG 30. In this case, it is possible to stop the piston 13 at a position in the first half of the expansion stroke. By this means, by suppressing occurrence of inverse rotation of the engine, it is possible to reduce vibration in association with the inverse rotation of the engine.

Specifically, a configuration is employed where it is determined that the piston is located at the last compression top dead center on the basis that the engine speed at the compression top dead center of the engine 11 is equal to or less than a predetermined value. Here, the predetermined value is a value from which it is determined that the piston 13 is stopped at the position in the first half of the expansion stroke by application of the counter torque. Therefore, it is possible to stop the piston 13 at a desired position, so that it is possible to reduce vibration in association with inverse rotation of the engine.

Further, a configuration is employed where a stop determining section is provided which determines whether or not the piston 13 is actually stopped at a desired position after the counter torque is applied, and in the case where it is determined that the piston 13 is stopped at the desired position, application of the counter torque is stopped. In this case, when rotation of the engine is stopped at a position of the first half of the expansion stroke, application of the counter torque is cancelled. By this means, it is possible to prevent inverse rotation of the engine due to counter torque.

A configuration is employed in which it is determined whether or not the piston 13 is located at a position at which compression reactive force is received at a time point at which rotation of the engine 11 is stopped, and, in the case where it is determined that the piston 13 is located at the position at which compression reactive force is received, positive torque is applied by the MG 30. In this case, it is possible to prevent the piston 13 from being pushed back by applying positive torque against the generated compression reactive force. By this means, it is possible to suppress occurrence of inverse rotation of the engine 11, so that it is possible to reduce vibration in association with the inverse rotation of the engine 11.

The magnitude of the compression reactive force received by the piston largely changes in accordance with the position of the piston when rotation of the engine 11 is stopped. For example, the compression reactive force received by the piston becomes greater as the position of the piston 13 is closer to the compression TDC. With the above-described configuration, a configuration is employed in which the position of the piston 13 when rotation of the engine 11 is stopped is estimated, and the torque value of the positive value is controlled on the basis of the position. By this means, it is possible to apply positive torque appropriate for the compression reactive force in accordance with the stop position of the piston 13.

The compression reactive force generated within the cylinder gradually decreases and finally disappears as air within the cylinder comes out as time passes. With the above-described configuration, after application of positive torque by the MG 30 is started, application of the positive torque is stopped in association with disappearance of the compression reactive force. By this means, it is possible to prevent the engine 11 from being rotated as a result of the positive torque becoming excessive when the compression reactive force disappears.

Further, the positive torque applied to the engine output shaft is also made to gradually decrease as time passes in accordance with change of the pressure within the cylinder. By this means, it is possible to maintain an appropriate balance between the compression reactive force and the positive torque.

A configuration is employed where, as backup processing of the crank angle stop processing, positive torque is applied. In this case, control is performed so that the piston 13 is stopped at a position in the first half of the expansion stroke by application of counter torque, and, further, in the case where the piston 13 is not stopped at the desired position, positive torque is applied. By this means, it is possible to further suppress occurrence of inverse rotation of the engine 11, so that it is possible to improve an effect of suppressing vibration.

In the rotation drop period during which the engine speed drops to zero after combustion of the engine 11 is stopped, counter torque is applied in the resonance range, and counter torque through the crank stop processing or positive torque as the backup processing is applied in the third period, by using the MG 30. By this means, it is possible to suppress also vibration in association with the inverse rotation of the engine as well as vibration in the resonance range. Further, in this case, it is possible to reduce an adverse effect of vibration in the resonance range on vibration due to inverse rotation. In this manner, by combining application of counter torque in the resonance range and processing in the third period, it is possible to synergistically suppress vibration occurring from when combustion of the engine 11 is stopped until when rotation of the engine 11 is stopped.

The present disclosure is not limited to the above-described embodiment, and, for example, may be implemented as below.

While, in the above-described embodiment, a configuration is employed where counter torque is applied by using the MG 30 as the auxiliary device, any auxiliary device which can apply counter torque to the engine output shaft may be used. Examples of the auxiliary device can include, for example, the auxiliary equipment 16 such as a water pump and a fuel pump. In this case, also in a vehicle in which the MG 30 is not installed, it is possible to apply counter torque by using a device which is normally provided to the vehicle. Therefore, it is not necessary to separately provide an additional device, which is economical.

Concerning application of counter torque in the resonance range, it is also possible to employ a configuration in which application of counter torque is started before the engine speed Ne reaches the boundary value A on the higher rotation side of the resonance range. In this case, for example, it is possible to employ a configuration in which, in step S18 in FIG. 3, the engine speed Ne is compared with the predetermined rotation speed Ne1 on the higher rotation side of the boundary value A of the resonance range, and in the case where the engine speed Ne falls below the threshold, application of counter torque is started.

According to this configuration, after combustion of the engine 11 is stopped, by applying counter torque before the engine speed reaches the resonance range, it is possible to improve response to the drop speed by the counter torque near the boundary value A of the resonance range. As a result, a time period during which the engine speed passes through the resonance range is further shortened, so that an effect of suppressing vibration is improved.

Further, it is also possible to employ a configuration in which, in the case where the engine speed Ne falls below self-recovery rotation speed, application of counter torque is started. In this case, for example, it is also possible to employ a configuration in which, in step S18 in FIG. 3, the engine speed Ne is compared with the predetermined rotation speed Ne1 set to the self-recovery rotation speed, and, in the case where the engine speed Ne falls below the threshold, application of counter torque is started. According to this configuration, in an early stage in which the engine speed starts to drop in association with stop of combustion of the engine, it is possible to expect a probability that the engine is autonomously recovered without the drop speed of the engine speed being increased. As a result, it is possible to improve response to the drop speed in the resonance range and improve an effect of suppressing vibration while reducing power consumption required for restart.

While, in the above-described embodiment, a configuration is employed in which, concerning application of counter torque in the resonance range, regenerative power generation or power running driving of the MG 30 is selected in accordance with the power consumption of the electric loads 36 connected to the battery 35, the state of the remaining capacity of the battery 35, the required torque required for application of counter torque, and the load by operation of the auxiliary equipment 16, regenerative power generation or power running driving may be selected in accordance with other parameters. Examples of other parameters can include rotation speed, and the like, of the MG 30.

Note that, in selection of the drive system of the MG 30, priorities may be set on the above-described parameters. For example, determination based on a driving state of the electric loads 36 may be taken on the top priority, and, subsequently, priorities may be set in order of the state of the remaining capacity of the battery 35, the required torque required for application of counter torque, and the load by operation of the auxiliary equipment 16.

While, in the above-described embodiment, the SOC of the battery 35 is used as the state of the remaining capacity of the battery 35, the state of the remaining capacity of the battery 35 is not limited to this, and, for example, a voltage between the terminals of the battery 35 may be used.

In the above-described embodiment, in the crank angle stop processing, timing for applying counter torque is judged based on whether or not the engine speed Ne at the compression TDC falls below the predetermined rotation speed Ne3. Concerning this point, the crank angle position at which the predetermined rotation speed Ne3 is set is not limited to the compression TDC, and the judging may be performed while the engine speed Ne at another crank angle position being set as the threshold. Note that, in this case, it is also possible to employ a configuration in which application of counter torque is started from the crank angle position at which the threshold is set.

While, in the above-described embodiment, in the crank angle stop processing, the predetermined rotation speed Ne3 is provided as the threshold of the engine speed to judge timing for applying counter torque, the judging method is not limited to this method. For example, it is also possible to use a method of judging the timing from a transition of drop of the engine speed Ne. In this case, the ECU 50, for example, calculates a rotation speed drop amount ΔNe from the engine speed Ne for each compression TDC and estimates a compression TDC (i) at which it is predicted that the engine speed Ne falls below zero. Then, it is possible to set timing at which the piston 13 reaches a compression TDC (i−1) immediately before the compression TDC (i) as timing for applying counter torque.

It is only necessary to employ a configuration in which the positive torque applied as backup processing of the crank angle stop processing is stopped after a predetermined time period has elapsed, and the positive torque may be stopped using a method in which the torque value is gradually reduced or a method in which the positive torque is stopped after a predetermined time period has elapsed while a constant torque value is maintained. Further, as a method for gradually reducing the torque value, for example, it is possible to use a method in which the torque value is reduced in a stepwise manner for each predetermined time period or a method in which the torque value is linearly reduced as time passes.

Further, it is also possible to detect an in-cylinder pressure by using an in-cylinder pressure sensor 55 and reduce the torque value while performing feedback control of adjusting the torque on the basis of the detected actual in-cylinder pressure. In this case, it is possible to apply positive torque with higher accuracy. By this means, it is possible to maintain an appropriate balance with the compression reactive force, so that it is possible to further suppress vibration in association with inverse rotation of the engine 11.

It is also possible to set a time period during which positive torque is applied on the basis of the estimated stop position of the piston in the backup processing. By this means, it is possible to apply positive torque in a period during which the compression reactive force in accordance with the position of the period is generated.

In the above-described embodiment, in the backup processing, the stop position of the piston 13 is estimated on the basis of the actual engine speed Ne at the predetermined angle position in step S45. Concerning this point, it is only necessary to employ a form in which the stop position of the piston 13 can be estimated, and the form is not limited to the above-described embodiment.

While, in the above-described embodiment, as the backup processing of the crank angle stop processing in the third period, positive torque is applied when rotation of the engine 11 is stopped, it is also possible to employ a configuration in which the application of positive torque is performed as single processing. Specifically, the ECU 50 determines whether or not the engine speed Ne is zero in a state where the third flag is fulfilled, and, in the case where the engine speed Ne is zero, positive torque is set (step S50), and positive torque is applied (step S52). By this means, it is possible to simplify the control system and reduce power consumption by suppressing frequency of driving the MG 30.

The above-described control in the rotation drop period until the engine speed becomes zero may be performed in a case of stop by ignition switch operation by the driver as well as in a case of automatic stop of the engine. Further, the above-described control may be performed in a case of stop in a vehicle which does not have an idling stop function.

While the present disclosure has been described with reference to the examples, the present disclosure is not limited to the examples and structures thereof. The present disclosure includes various modified examples and modifications within an equivalent range. In addition, various combinations, forms, and other combinations and forms including only one element or more or less elements therein fall within the scope and the spirit of the present disclosure.

1. An engine control apparatus which is applied to an engine system including an engine in which a cycle including each stroke of compression and expansion is repeatedly performed, and a rotating electrical machine which is capable of applying positive torque on a positive rotation side and counter torque on an inverse rotation side to an engine output shaft, the engine control apparatus comprising:
a determining section configured to determine whether or not a piston is located at a position, at which compression reactive force is received, at a time point at which engine speed reaches zero after combustion of the engine is stopped; and
a torque control section configured to, in a case where it is determined by the determining section that the piston is located at the position at which the compression reactive force is received, stop the piston by applying positive torque on a positive rotation side to the engine output shaft by the rotating electrical machine.

2. The engine control apparatus according to claim 1, comprising:
an estimating section configured to estimate the position of the piston at the time point at which the engine speed reaches zero,
wherein the torque control section controls a torque value by the rotating electrical machine based on the position of the piston estimated by the estimating section.

3. The engine control apparatus according to claim 1,
wherein, after application of the positive torque by the rotating electrical machine is started, the torque control section stops the application of the positive torque in association with disappearance of the compression reactive force.

4. The engine control apparatus according to claim 1,
wherein the torque control section gradually reduces the positive torque as time passes from the time point at which the engine speed reaches zero.

5. The engine control apparatus according to claim 1, comprising:
an estimating section configured to estimate a position of the piston at the time point at which the engine speed reaches zero,
wherein the torque control section sets a time period during which torque is applied by the rotating electrical machine based on the position of the piston estimated by the estimating section.

6. The engine control apparatus according to claim 1, comprising:
a rotation speed determining section configured to determine that the piston is located at a compression top dead center immediately before the engine speed becomes zero based on engine speed at the compression top dead center of the engine in a rotation drop period during which the engine speed drops to zero after the combustion of the engine is stopped; and
a stop determining section configured to determine whether or not the piston is stopped at a rotation angle position in a first half period of the expansion stroke,
wherein, in a case where it is determined by the rotation speed determining section that the piston is located at the compression top dead center immediately before the engine speed becomes zero, the torque control section applies counter torque by the rotating electrical machine from the compression top dead center, and,
in a case where it is determined by the stop determining section that the piston is not stopped at the rotation angle position in the first half period of the expansion stroke after the counter torque is applied by the rotating electrical machine, the torque control section stops the piston by applying positive torque on the positive rotation side to the engine output shaft by the rotating electrical machine.
